(19) United States
(12) Patent Application Publication
(10) Pub. No.: US 2015/0095985 A1
(43) Pub. Date: Apr. 2, 2015

(54) Parental Control System For Controlling Access To Online Store Contents

(71) Applicant: Alcatel-Lucent USA Inc., Murray Hill, NJ (US)

(72) Inventors: Suzann Hua, Lisle, IL (US); Yigang Cai, Naperville, IL (US)

(73) Assignee: ALCATEL-LUCENT USA INC., Murray Hill, NJ (US)

(21) Appl. No.: 14/039,035

(22) Filed: Sep. 27, 2013

(51) Int. Cl. H04L 29/06

(52) U.S. Cl. CPC H04L 63/08
USPC 726/4

(57) ABSTRACT

A parental control system for controlling child access to objectionable or age-inappropriate online content is disclosed, implemented in one embodiment within a service platform associated with an online media store. The service platform maintains a parental control menu, accessible by responsible authorities (e.g., parents/guardians and store administrators) to identify child users, to specify allowed or objectionable content items or categories and to specify allowed or blocked transactions relating to those items or categories for certain ages of children or for individual children. When a child user accesses the online media store, the service platform consults the parental control menu to determine which content and which types of transactions (e.g., browsing, previews, downloads) should be enabled or blocked.

### FIELD OF THE INVENTION

This invention relates generally to communication systems and, more particularly, to parental controls/tools for controlling child access to objectionable or age-inappropriate online content.

### BACKGROUND OF THE INVENTION

The Internet is a well-known communication system in which users can access various network entities to perform online activities or transactions. As one example, users can access online media stores to browse, preview and download digital media content including applications (or “apps,” including mobile apps), electronic books (or “e-books”), music and video. Increasingly, users of online media stores include child users (e.g., under age 13), yet much of the content available from online media stores may be considered objectionable or age-inappropriate to children. Advantageously, child users should be enabled to access online media content that is deemed suitable for their age/maturity level, yet restricted, to an extent determined by responsible authorities (including in one aspect, parents/guardians and, in another aspect, online media store administrators) from accessing online media content that is deemed objectionable or age-inappropriate. For example, a child might advantageously be blocked from browsing, previewing and downloading certain content items or categories. Alternatively or additionally, a child might advantageously be blocked from some transactions (e.g., downloading) but allowed other transactions (e.g., browsing or previewing) relating to certain content items or categories. Presently, however, there is not an efficient way for responsible authorities to control child access to objectionable online media store content. One difficulty is that content ratings may not exist for some media store content, and responsible authorities may differ as to which content restrictions are appropriate for certain ages of children or for certain individual children.

### SUMMARY OF THE INVENTION

This problem is addressed and a technical advance is achieved in the art by a parental control system, implemented in one embodiment within a service platform associated with an online media store for controlling child access to objectionable or age-inappropriate online content. The service platform maintains a parental control menu, accessible by responsible authorities (e.g., parents/guardians and store administrators) to identify child users, to specify allowed or objectionable content items or categories and to specify allowed or blocked transactions relating to those items or categories for certain ages of children or for individual children. When a child user accesses the online media store, the service platform consults the parental control menu to determine which content and which types of transactions (e.g., browsing, previews, downloads) should be enabled or blocked.

In one embodiment, there is provided a method performed by a service platform associated with an online media store. The service platform identifies one or more child users, identifies one or more parental authorities associated with the child users and identifies a number of content restrictions associated with the child users. The content restrictions include parent-specified content restrictions specified for respective child users by their respective parental authorities, in one embodiment, via a parental control menu. The service platform controls child access to one or more digital media content items based on the content restrictions.

In one embodiment, there is provided an apparatus comprising a processor and memory. The processor is operably coupled to the memory and configured to identify one or more child users, identify one or more parental authorities associated with the child users and identify a number of content restrictions associated with the child users. The content restrictions include parent-specified content restrictions specified for respective child users by their respective parental authorities, in one embodiment, via a parental control menu. The processor is further configured to control child access to one or more digital media content items based on the content restrictions.

### BRIEF DESCRIPTION OF THE DRAWINGS

The foregoing and other advantages of the invention will become apparent upon reading the following detailed description and upon reference to the drawings in which:

FIG. 1 illustrates a communication network including an online media store in an exemplary embodiment of the invention;

FIG. 2 is a block diagram of a service platform associated with the online media store in an exemplary embodiment of the invention;

FIG. 3 is a flowchart showing steps performed by the service platform for controlling child access to digital media content in an exemplary embodiment of the invention; and

FIG. 4 is a flowchart showing steps performed by the service platform for restricting child user downloads of digital media content in an exemplary embodiment of the invention.

### DESCRIPTION OF THE PREFERRED EMBODIMENT(S)

FIG. 1 illustrates a communication network 100 implementing a parental control system for controlling child access to objectionable or age-inappropriate online content. Communication network 100 comprises a data network 102, e.g., the Internet, operably linked to various user platforms 104 (two shown, representing a child user and the child's parent). The user platforms 104 comprise, for example and without limitation, mobile computing devices (e.g., smartphones, tablets), laptop computers or desktop computers, subject to operation by users to access various network entities (e.g., websites) to perform some kind of online activities or transactions. The user platforms 104 are linked to an online media store 106 containing or having access to digital media content (not shown). The digital media content may comprise, for example and without limitation, apps (including mobile apps), e-books, music and video.

As will be appreciated, the online media store 106 is a functional element that may reside individually or collectively in one or more physical structures or may be implemented in software. The online media store will be understood to include a service platform comprising, for example and without limitation, a server, platform or network entity that hosts websites or online services in which users 104 may perform online activities or transactions including browsing, previews or downloads of the digital media content. [For convenience, the online media store and service platform are considered to be like elements and will hereinafter be identified by the same reference numeral.] According to embodiments hereinafter to be described in greater detail, the service platform 106 maintains user data 108 in the form of service profiles (identifying, for example, which users are child users, and identifies various content restrictions associated with the child users) and maintains a parental control menu 110 that allows parents to identify their children and define (or redefine) the content restrictions that they wish to be applied to their children. The links between the users 104 and the service platform 106 are functional links that may be implemented using any appropriate transmission, switching and routing technologies, including but not limited to wireline and wireless technologies.

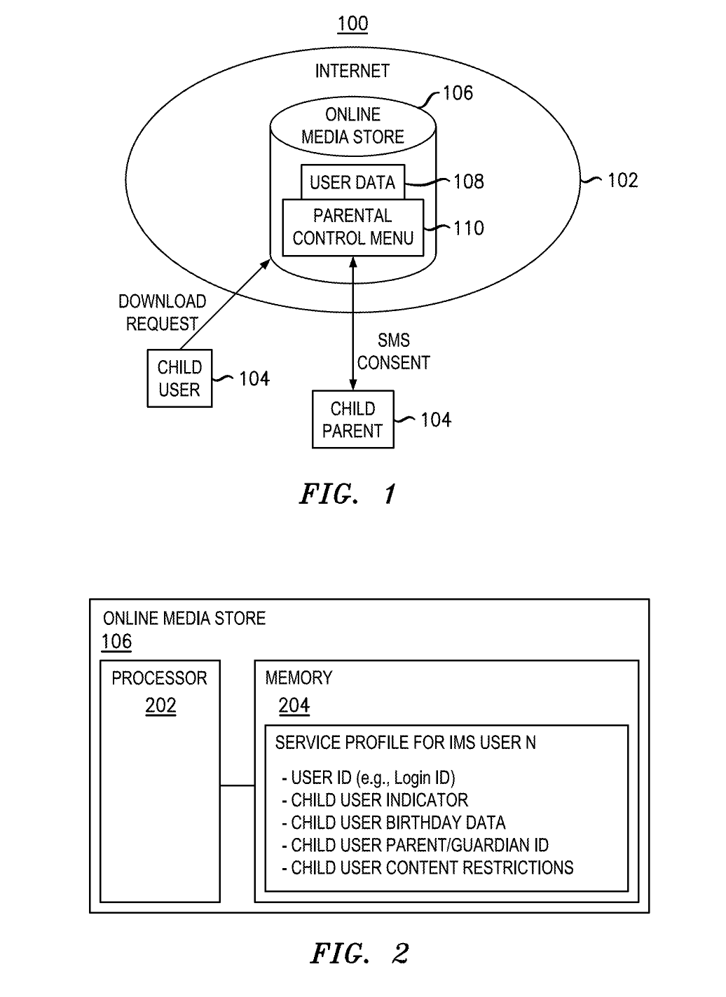

FIG. 2 shows a block diagram of the service platform 106 of the online media store. The service platform 106 includes a processor 202 and memory 204 for effecting transactions with the users 104 and to execute parental control features for controlling child access to objectionable or age-inappropriate online content. Generally, the processor 202 is operable to execute program code stored in memory 204 (e.g., including but not limited to operating system firmware/software and application software) to execute user transactions and parental control features; and the memory 204 is operable to store user data in the form of service profiles indexed to various users, including child users. As shown, a service profile for exemplary user N includes a user ID (e.g., login ID) and a child user indicator (e.g., yes/no). The service profile further includes, for child users, items of child-specific information content (as shown, child user birthday data, child user parent/guardian ID and child user content restrictions). As will be appreciated, the service profile may include additional information not shown in FIG. 2, for child users or other than child users.

In one embodiment, the service platform obtains user data at least in part via the parental control menu 110, i.e., including user data 108 contributed at least in part by parent/guardian interactions with the parental control menu. For example, it is contemplated that a parent user 104 may utilize the parental control menu 110 to identify their children (e.g., by providing the children's social security number, birth date and login ID), identify themselves as parents/guardians (e.g., by providing social security number and login ID), identify various parent-specified content restrictions that they wish to impose on their children and provide periodic updates/changes, and such data is stored in the memory 204 of the service platform. The parental control menu may comprise, for example, a webpage or other user suitable user interface that interacts and receives data from parent/guardian users 104. The content restrictions may identify, for example and without limitation, allowed or blocked content items or categories or allowed or blocked transactions associated with one or more content items or categories. The allowed or blocked transactions may specify, for example and without limitation, restrictions on browsing, previews and/or downloads associated with one or more content items or categories.

Optionally, the user data 108 may be entered in part by an administrator of the online media store and entered in part by interaction of parents/guardians with the parental control menu 110. For example, it is contemplated that an administrator might identify default settings of allowed or blocked content items or categories or blocked transactions associated with one or more content items or categories, and parents may interact with the parental control menu to make periodic adjustments (i.e., selected changes) to the default settings or to endorse the default settings. Further optionally, user data may be contributed by parents/guardians via message traffic (e.g., SMS messages) with the service platform 106 independent of the parental control menu.

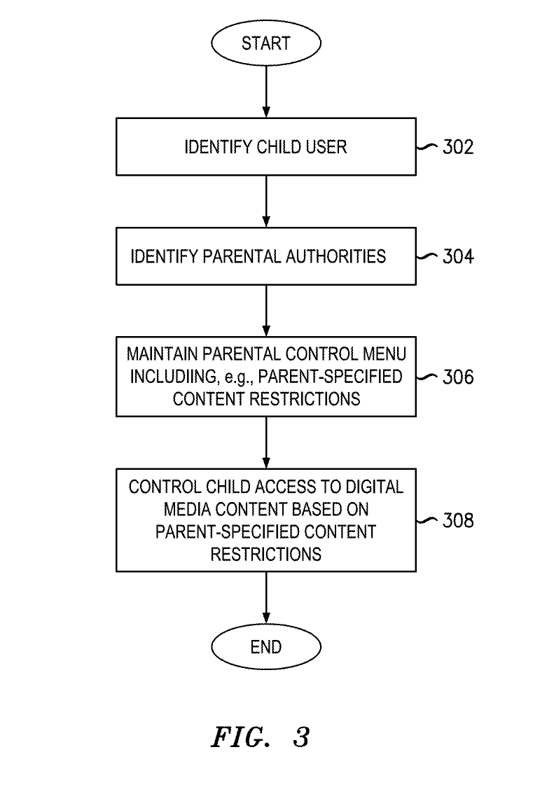

FIG. 3 is a flowchart showing steps performed by the service platform 106 for controlling child access to digital media content in an exemplary embodiment of the invention. The method is implemented, in one embodiment, by the processor 202 and/or memory 204 of the service platform 106. For convenience, the steps of FIG. 3 will be described generally as performed by the service platform 106. The steps of FIG. 3 need not be performed in the order shown.

At step 302, the service platform 106 identifies one or more child users, and at step 304, one or more parental authorities (e.g., parents/guardians) of the child users indexed to respective user IDs (e.g., login IDs). In one embodiment, the service platform identifies which users are child users and which adult users are parent/guardians of the child users based at least in part on user data contributed by parents/guardians via the parental control menu. For example, as described in relation to FIG. 2, a parent user may utilize the parental control menu to identify their children (e.g., by providing the children's social security number, birth date and login ID) and identify themselves as parents/guardians of the child user. As will be appreciated, child users may defined as users meeting a designated child age criteria, such as 13 years of age or younger; or may be partitioned among multiple age-based categories. In one embodiment, the service platform consults the birthday data to ascertain the age of child users and identify/confirm them as child users (and if applicable, to identify the appropriate age-based category). In one embodiment, the service platform maintains a child user indicator indexed with respective user IDs, indicating which users are child users (and if applicable, which age-based category is appropriate) and the child user indicator is maintained in the service profile of child users.

At step 306, the service platform maintains the parental control menu. In one embodiment, the parental control menu defines a web-based interface (e.g., web page or the like) with which parent/guardian users 104 may interact and contribute data associated with their respective children, including parent-specified content restrictions that they wish to impose on their children. Parent-specified content restrictions may comprise, for example and without limitation, allowed or blocked content items or categories or allowed or blocked transactions associated with one or more content items or categories. The allowed or blocked transactions may specify, for example and without limitation, restrictions on browsing, previews and/or downloads associated with one or more content items or categories. As noted in relation to steps 302, 304, parent users may also utilize the parental control menu to identify their children and identify themselves as parents/guardians of respective child users.

At step 308, the service platform controls child access to digital media content based on parent-specified content restrictions. Accordingly, the service platform may allow or block access to specified content items or categories or allowed or blocked specified transactions associated with one or more content items or categories. For example and without limitation, the service platform may allow or block transactions including browsing, previews and/or downloads associated with one or more content items or categories. More particularly, the service platform may allow certain transactions (e.g., browsing) and block other transactions (e.g., previews, downloads) associated with one or more content items or categories.

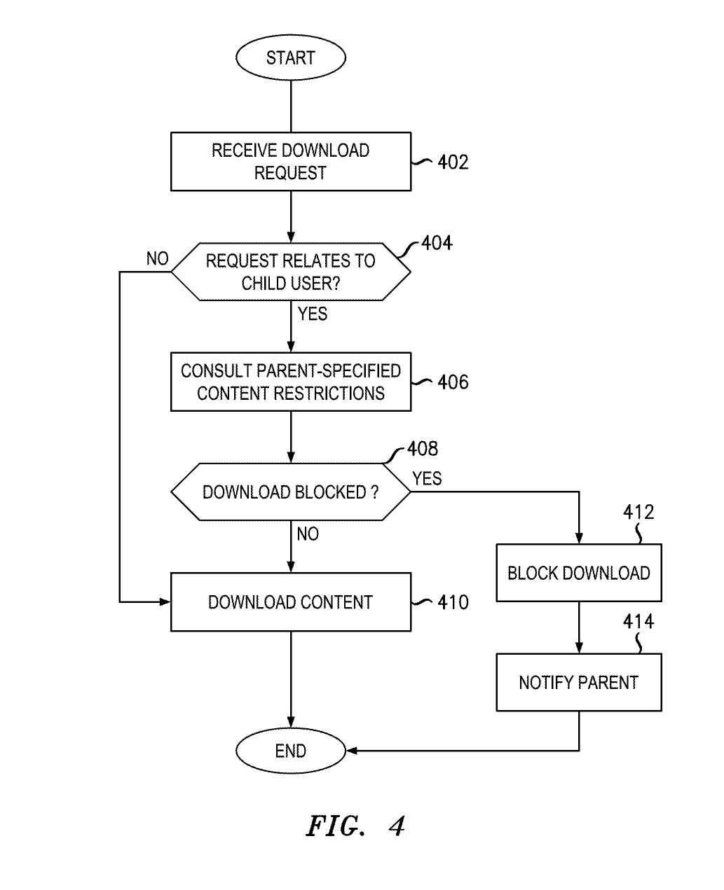

FIG. 4 is a flowchart showing steps performed by the service platform 106 for restricting child user downloads of digital media content in an exemplary embodiment of the invention. The method is implemented, in one embodiment, by the processor 202 and/or memory 204 of the service platform 106. For convenience, the steps of FIG. 4 will be described generally as performed by the service platform 106. The steps of FIG. 4 need not be performed in the order shown.

At step 402, the service platform receives a download request from a user 104. For example, with reference to FIG. 1, the service platform may receive a download request from the child user 104 or the child parent 104 (or any other user). Generally, coincident to the download request, the user 104 identifies a content item or items that they wish to download and the service platform prompts the user to enter their user ID (e.g., login ID) and password.

At step 404, the service platform consults the service profile indexed with the user ID to determine whether the user having initiated the download request is a child user (and if applicable, which age-based category applies to the user). If the download request is not initiated by a child user, the service platform initiates downloading of the requested content at step 410. If the download request is initiated by a child user, the process proceeds to step 406.

At step 406, having determined that the download request is initiated by a child user, the service platform consults the service profile to identify any content restrictions, including parent-specified content restrictions applicable to the user. The parent-specified content restrictions may have been entered, for example, via the parent control menu. Optionally, the service platform may prompt the child user to enter their parent/guardian ID or contact information, so that the service platform or administrator may contact the parent/guardian, for example, to confirm or inquire about parent-specified content restrictions. As previously noted, content restrictions may comprise allowed or blocked content items or categories or allowed or blocked transactions associated with one or more content items or categories. The allowed or blocked transactions may further specify restrictions on browsing, previews and/or downloads associated with one or more content items or categories.

At step 408, the service platform determines, based on content restrictions applicable to the child user, whether the child user is blocked from downloading the requested content. For example, the child may be blocked from downloading the requested content if the requested content is specified in the service profile as a blocked content item, or within a blocked category, or the downloading transaction is specified as a blocked transaction. Or the child may be allowed to download the requested content if it is specified as an allowed content item, or within an allowed category, or the downloading transaction is specified as an allowed transaction for the requested content. If the download request is allowed, the service platform initiates downloading of the requested content at step 410.

If the download request is blocked, the service platform blocks download of the requested content at step 412. At step 414, the service platform sends an SMS message or other message modality to the child's parent/guardian, to inform the parent/guardian of the blocked download attempt and to offer the parent an opportunity to override the applicable parent-specified content restrictions (e.g., to consent to downloads of the requested content). The message may include, for example, a title and/or category of the content and a link that has a more detailed description of the content. At substantially or nearly the same time, the service platform may indicate to the child user that the download attempt has been blocked because of parent-specified content restrictions, or that downloading is blocked pending parental consent. Thereafter, depending on the response from the parent, the service platform may either allow the downloading based on parental consent or indicate to the child user that downloading is not allowed.

FIGS. 1-4 and the foregoing description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. The scope of the invention is, therefore, not limited to the specific embodiments described herein, but indicated by the appended claims.

What is claimed is:

1. In a communication system including an online media store containing a plurality of digital media content items, a method, performed by a service platform associated with the online media store, comprising:
identifying one or more child users;
identifying one or more parental authorities associated with the child users;
identifying a number of content restrictions associated with the child users, the content restrictions including parent-specified content restrictions specified for respective child users by their respective parental authorities; and
controlling child access to one or more digital media content items based on the content restrictions.

2. The method of claim 1, wherein the step of identifying content restrictions comprises identifying one or more: allowed or blocked content items or allowed or blocked content categories.

3. The method of claim 2, wherein the step of identifying content restrictions further comprises identifying one or more allowed or blocked transactions associated with one or more content items or categories.

4. The method of claim 3, wherein the allowed or blocked transactions include one or more of: browsing, previews and downloads, the step of controlling child access comprising allowing or blocking one or more of: browsing, previews and downloads associated with one or more content items or categories.

5. The method of claim 1, further comprising maintaining a parental control menu for receiving indicia of parent-specified content restrictions.

6. The method of claim 5, wherein the step of identifying content restrictions comprises receiving via the parental control menu, indicia of one or more parent-specified: allowed or blocked content items or allowed or blocked content categories.

7. The method of claim 6, wherein the step of identifying content restrictions comprises:
identifying one or more default allowed or blocked content items or default allowed or blocked content categories; and
receiving via the parental control menu, indicia of parental adjustments to the default allowed or blocked content items or allowed or blocked content categories.

8. The method of claim 6, wherein the step of identifying content restrictions further comprises receiving via the parental control menu, indicia of one or more parent-specified allowed or blocked transactions associated with one or more content items or categories.

9. The method of claim 8, wherein the parent-specified allowed or blocked transactions include one or more of: browsing, previews and downloads, the step of controlling child access comprising allowing or blocking one or more of: browsing, previews and downloads associated with one or more content items or categories.

10. The method of claim 8, wherein the step of identifying content restrictions further comprises receiving via the parental control menu, indicia of one or more parent-specified cost thresholds associated with one or more content items or categories, the step of controlling child access comprising allowing or blocking one or more content items or categories based on the parent-specified cost thresholds.

11. An apparatus comprising:
a memory; and
at least one processor operably coupled to the memory and configured to:
identify one or more child users;
identify one or more parental authorities associated with the child users;
identify a number of content restrictions associated with the child users, the content restrictions including parent-specified content restrictions specified for respective child users by their respective parental authorities; and
control child access to one or more digital media content items based on the content restrictions.

12. The apparatus of claim 11, wherein coincident to identifying content restrictions, the processor is configured to identify one or more: allowed or blocked content items or allowed or blocked content categories.

13. The apparatus of claim 12, wherein coincident to identifying content restrictions, the processor is further configured to identify one or more allowed or blocked transactions associated with one or more content items or categories.

14. The apparatus of claim 13, wherein the allowed or blocked transactions include one or more of: browsing, previews and downloads, wherein coincident to controlling child access, the processor is configured to allow or block one or more of: browsing, previews and downloads associated with one or more content items or categories.

15. The apparatus of claim 11, wherein the processor is further configured to maintain a parental control menu for receiving indicia of parent-specified content restrictions.

16. The apparatus of claim 15, wherein coincident to identifying content restrictions, the processor is configured to receive via the parental control menu, indicia of one or more parent-specified: allowed or blocked content items or allowed or blocked content categories.

17. The apparatus of claim 16, wherein coincident to identifying content restrictions, the processor is configured to:
identify one or more default allowed or blocked content items or default allowed or blocked content categories; and
receive via the parental control menu, indicia of parental adjustments to the default allowed or blocked content items or allowed or blocked content categories.

18. The apparatus of claim 16, wherein coincident to identifying content restrictions, the processor is further configured to receive via the parental control menu, indicia of one or more parent-specified allowed or blocked transactions associated with one or more content items or categories.

19. The apparatus of claim 18, wherein the parent-specified allowed or blocked transactions include one or more of: browsing, previews and downloads, wherein coincident to controlling child access, the processor is configured to allow or block one or more of: browsing, previews and downloads associated with one or more content items or categories.

20. The apparatus of claim 18, wherein coincident to identifying content restrictions, the processor is further configured to receive via the parental control menu, indicia of one or more parent-specified cost thresholds associated with one or more content items or categories, and wherein coincident to controlling child access, the processor is configured to allow or block one or more content items or categories based on the parent-specified cost thresholds.
